(19) United States
(12) Patent Application Publication
(10) Pub. No.: US 2026/0339329 A1
(43) Pub. Date: Oct. 29, 2026

(54) UNMANNED AERIAL VEHICLE, INFORMATION PROCESSING APPARATUS, CONTROL METHOD FOR UNMANNED AERIAL VEHICLE, AND STORAGE MEDIUM

(71) Applicant: CANON KABUSHIKI KAISHA, Tokyo (JP)

(72) Inventor: TAKASHI YAMAGUCHI, Kanagawa (JP)

(21) Appl. No.: 19/635,905

(22) Filed: Apr. 1, 2026

(30) Foreign Application Priority Data
Apr. 28, 2025 (JP) 2025-074946

(51) Int. Cl. G05D 1/48; G06V 10/26; G06V 20/17; G05D 109/25; G05D 111/10

(52) U.S. Cl. CPC G05D 1/48; G06V 10/26; G06V 20/17; G05D 2109/254; G05D 2111/10; G06V 2201/07

(57) ABSTRACT

An unmanned aerial vehicle includes a flight unit configured to cause the unmanned aerial vehicle to fly at a predetermined altitude; an imaging unit configured to obtain images by performing imaging in a state in which the unmanned aerial vehicle is flying; at least one memory storing instructions; and at least one processor executing the stored instructions causing the unmanned aerial vehicle to: detect an obstruction in a target area to be imaged by the imaging unit from an image in which the target area is captured from above the target area; and determine, according to a result of the detection, an altitude of the unmanned aerial vehicle during capturing the target area by the imaging unit.

### BACKGROUND

### Field of the Technology

The present disclosure relates to an unmanned aerial vehicle, an information processing apparatus, a control method for an unmanned aerial vehicle, and a storage medium.

### Description of the Related Art

Conventionally, there exists a technology in which an unmanned aerial vehicle including an imaging apparatus performs imaging while in a flying state in order to search for lost articles, persons in distress, and the like. Such a search is performed, for example, based on an image captured by the imaging apparatus of the unmanned aerial vehicle. Japanese Patent Laid-Open No. 2023-19846 discloses a technology in which an expected value is calculated from a position at which an article was lost and a movement state before the loss, based on radio waves received from a transmitter provided in the lost article, and the unmanned aerial vehicle flies in an area having a high expected value to search for the lost article. Additionally, U.S. Patent Application Publication No. 2022/0262263 discloses an unmanned aerial vehicle that captures images within a search range and identifies a target that matches an image of the target.

Here, in a case in which there is an occluding object with respect to a subject to be imaged by the imaging apparatus, suitable imaging conditions may differ.

### SUMMARY

According to an aspect of the present disclosure, an unmanned aerial vehicle includes a flight unit configured to cause the unmanned aerial vehicle to fly at a predetermined altitude; an imaging unit configured to obtain images by performing imaging in a state in which the unmanned aerial vehicle is flying; at least one memory storing instructions; and at least one processor executing the stored instructions causing the unmanned aerial vehicle to: detect an obstruction in a target area to be imaged by the imaging unit from an image in which the target area is captured from above the target area; and determine, according to a result of the detection, an altitude of the unmanned aerial vehicle during capturing the target area by the imaging unit .

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of a search system.

FIG. 2 is a hardware configuration diagram of an unmanned aerial vehicle and an external apparatus.

FIG. 3 is a diagram illustrating an external appearance of the unmanned aerial vehicle.

FIG. 4 is a diagram illustrating a relation between a search state by the unmanned aerial vehicle and an altitude of the unmanned aerial vehicle.

FIG. 5 is a diagram illustrating an evaluation target image.

FIG. 6 is a diagram illustrating an evaluation map.

FIG. 7 is a flowchart illustrating the flow of search processing.

FIGS. 8A and 8B are diagrams illustrating flight conditions and imaging conditions as a search plan determined by a search planning unit.

### DESCRIPTION OF THE EMBODIMENTS

Hereinafter, embodiments of the present disclosure will be explained with reference to the drawings.

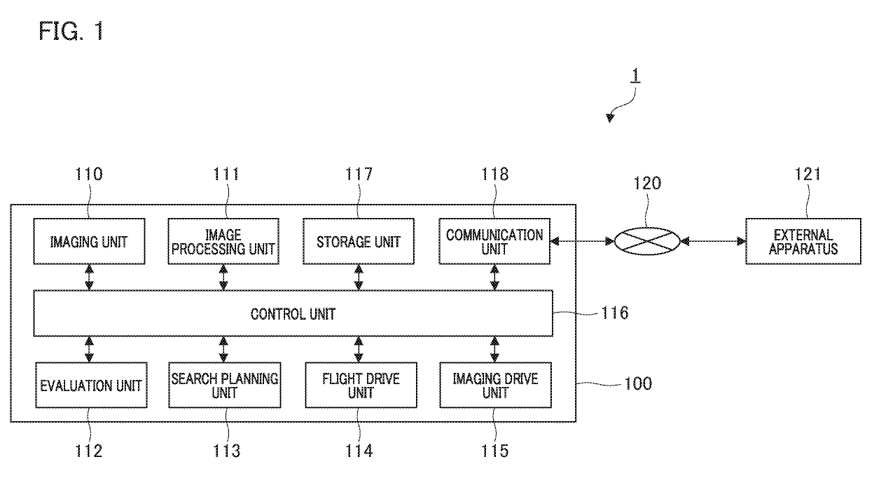

FIG. 1 is an overall configuration diagram of a search system 1. The search system 1 is a system that searches for an object from an image captured in a state in which an unmanned aerial vehicle is caused to fly.

The search system 1 includes an unmanned aerial vehicle 100 and an external apparatus 121. The unmanned aerial vehicle 100 and the external apparatus 121 are connected via a network 120.

The unmanned aerial vehicle 100, which is an example of an information processing apparatus, is an autonomously moving device that images a subject while in a flying state. As the unmanned aerial vehicle 100, for example, a drone may be used.

The unmanned aerial vehicle 100 includes an imaging unit 110, an image processing unit 111, an evaluation unit 112, a search planning unit 113, a flight drive unit 114, an imaging drive unit 115, a control unit 116, a storage unit 117, and a communication unit 118.

The imaging unit 110 includes an imaging optical system (not illustrated) that is configured by a plurality of lenses and a holding member, and an imaging sensor (not illustrated), and images a subject. The imaging optical system includes a zoom lens, a focus lens, and an aperture mechanism, and condenses light from the subject onto a light receiving surface of the imaging sensor. The zoom lens and the focus lens are movable in an optical axis direction by a motor and are used to change the imaging magnification and a focal position. The aperture mechanism includes a motor and adjusts the amount of light that passes through the imaging optical system. Each motor provided in the imaging unit 110 is driven by the imaging drive unit 115. The image sensor includes a semiconductor element such as a Complementary Metal Oxide Semiconductor (CMOS) sensor or a Charge Coupled Device (CCD) sensor. Light transmitted through the imaging optical system is formed into an image on the image sensor and converted into an electrical signal. In the present embodiment, the image sensor has sensitivity to light in a visible light range, but is not limited thereto, and may have sensitivity to light in a non-visible light range such as infrared light.

The image processing unit 111 performs various types of image processing, such as development processing, color balance processing, gamma processing, and noise reduction processing, on an output signal of the imaging unit 110, and generates an image.

Here, the imaging unit 110 and the image processing unit 111 are regarded as an imaging unit that obtains an image by imaging. Additionally, hereinafter, an image that has been captured by the imaging unit 110 and generated by the image processing unit 111 may be referred to as a captured image.

The evaluation unit 112, which is an example of an obstruction detection unit, detects a specific object from a captured image and evaluates the ease of search therefor based on a result of the detection. The specific object is an object that has been predetermined as an object that will hinder the search. Additionally, examples of an object that has been predetermined as an object that will hinder the search include an obstruction and an object having a predetermined appearance. Additionally, examples of an occluding object include an object that occludes a search target and an object that occludes a target to be imaged by the unmanned aerial vehicle 100 for the search. Examples of an object having a predetermined appearance include an object having a color that has been predetermined as being difficult to distinguish from the search target and an object having a shape that has been predetermined as being difficult to distinguish from the search target. Note that an object predetermined that has been predetermined to be an object that will hinder the search may hereinafter be referred to as an interfering object. Additionally, an area to be imaged by the unmanned aerial vehicle 100 for the search may hereinafter be referred to as an area to be imaged.

Detection of the interfering object from the captured image by the evaluation unit 112 is performed, for example, by comparing an image showing an object that has been predetermined to be an interfering object with a subject shown in the captured image. However, the evaluation unit 112 may detect, as a region in which the interfering object is shown, a region in the captured image having a high contrast ratio or high complexity with respect to adjacent pixels. Additionally, the evaluation unit 112 may perform machine learning with respect to a relation between a subject shown in the image and the interfering object and detect the interfering object from the image based on a result of the machine learning. Additionally, for example, the interfering object shown in the captured image may be detected by a user operating the unmanned aerial vehicle 100 or the external apparatus 121.

Additionally, the evaluation unit 112 evaluates the ease of search to be higher for a region in the captured image having fewer interfering objects and evaluates the ease of search to be lower for a region in the captured image having more interfering objects. Note that the evaluation unit 112 may evaluate the ease of search to be higher for a region in which an area, and a volume that are occupied by the interfering object in the captured image are smaller and may evaluate the ease of search to be lower for a region in which an area, and a volume that are occupied by the interfering object in the captured image are larger. The result of evaluation by the evaluation unit 112 may be classified into any number of stages, provided that the number of stages is two or more.

The search planning unit 113, which is an example of a determination unit, determines a search plan by determining flight conditions and imaging conditions of the unmanned aerial vehicle 100 in the area to be imaged based on the result of evaluation by the evaluation unit 112. Examples of flight conditions that are determined by the search planning unit 113 include a flight altitude, a flight route, a flight speed, an orientation during flight, a hovering position and a hovering time for when imaging is performed. Additionally, examples of imaging conditions that are determined by the search planning unit 113 include an imaging direction of the imaging unit 110. Note that, an altitude, a flight speed, an orientation during flight, a hovering position, and a hovering time of the unmanned aerial vehicle 100 define the imaging mode of the unmanned aerial vehicle 100. Therefore, the altitude, the flight speed, the orientation during flight, the hovering position, and the hovering time of the unmanned aerial vehicle 100 are also regarded as imaging conditions of the unmanned aerial vehicle 100.

The search planning unit 113 may also be made to determine a higher flight altitude the higher that the evaluation by the evaluation unit 112 in the area to be imaged becomes, such that wider-angle imaging is performed by the unmanned aerial vehicle 100. Additionally, the search planning unit 113 may determine a lower flight altitude the lower that an evaluation by the evaluation unit 112 in the area to be imaged becomes, such that imaging of a search target by the unmanned aerial vehicle 100 is not obstructed by an obstruction. Additionally, the search planning unit 113 determines the altitude based on optical information of the imaging unit 110. Additionally, in a case in which a plurality of regions to be imaged that have different evaluations by the evaluation unit 112 exist, the search planning unit 113 determines a flight route such that changes in altitude are reduced. Accordingly, the search time is shortened and the power consumption accompanying changes in altitude is suppressed in comparison with a case in which changes in altitude are frequent.

The flight drive unit 114, which is an example of a flight unit, includes a plurality of propellers, an accelerometer, a self-position detection device that uses Global Positioning System(GPS), and the like, and controls the flight of the unmanned aerial vehicle 100 by controlling an altitude, a speed, a position, and an attitude of the unmanned aerial vehicle 100. In the present embodiment, the flight drive unit 114 causes the unmanned aerial vehicle 100 to fly in accordance with the flight conditions that have been determined by the search planning unit 113.

The imaging drive unit 115 drives the imaging optical system of the imaging unit 110 that has been described above. Additionally, the imaging drive unit 115 drives a rotation mechanism for changing the imaging direction of the imaging unit 110 with respect to the unmanned aerial vehicle 100. More specifically, control is performed to change the imaging direction of the imaging unit 110 in a pan direction and a tilt direction with respect to the unmanned aerial vehicle 100. However, the imaging direction of the imaging unit 110 may be realized, for example, by the flight drive unit 114 changing an orientation of the unmanned aerial vehicle 100.

The control unit 116 controls the entirety of the unmanned aerial vehicle 100 by controlling each functional unit of the unmanned aerial vehicle 100. Control by the control unit 116 includes the setting of various parameters, and issuing instructions for the transmission and reception of information. Additionally, the control unit 116 detects a search target from the captured image. Any method may be used as the method by which the control unit 116 detects the search target.

The storage unit 117 stores information such as captured images, results of evaluations by the evaluation unit 112, results of determinations by the search planning unit 113, and search conditions that are input by a user. Additionally, the storage unit 117 is used as a program storage area for programs that are executed by the control unit 116, a storage area for various parameters, and a work area that is used during the execution of programs.

The communication unit 118 converts information such as flight conditions, imaging conditions, and captured images of the unmanned aerial vehicle 100 in accordance with a communication protocol, and transmits the converted information to the external apparatus 121. Additionally, the communication unit 118 receives, from the external apparatus 121, information including setting commands for various parameters for the unmanned aerial vehicle 100, outputs the received information to the control unit 116, and transmits a response to the external apparatus 121.

The external apparatus 121, which is an example of an information processing apparatus, communicates with the unmanned aerial vehicle 100 via the network 120, and transmits and receives information to and from the unmanned aerial vehicle 100. The external apparatus 121 displays or stores captured images that have been received from the unmanned aerial vehicle 100. Additionally, in accordance with a user operation, the external apparatus 121 specifies a search range, a search target, search conditions, and the like, and transmits information indicating a result of the specification to the unmanned aerial vehicle 100.

Examples of the external apparatus 121 include a computer device such as a PC or a mobile terminal.

The network 120 is a wireless Local Area Network (LAN), and is configured by routers, switches, and the like that comply with communication standards such as Wi-Fi (registered trademark). It should be noted that the network 120 is not limited as to its communication standard, scale, or configuration, provided that communication between the unmanned aerial vehicle 100 and the external apparatus 121 can be realized, and may further be configured to have a configuration in which communication is performed via a cloud.

Additionally, the number of unmanned aerial vehicles 100 provided in the search system 1 is not particularly limited and may be set to any number.

Additionally, various functional configuration units of the unmanned aerial vehicle 100, including the search planning unit 113, may be provided in the external apparatus 121.

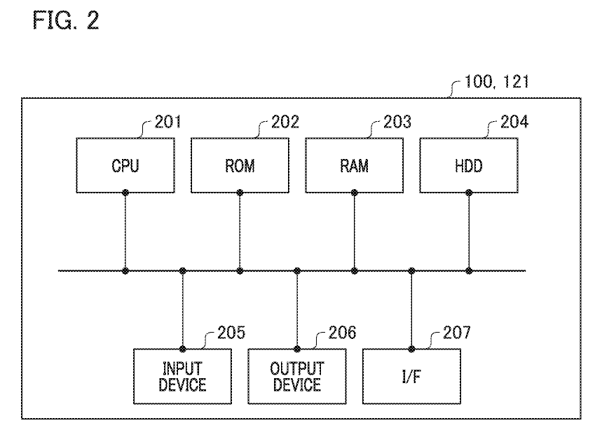

FIG. 2 is a hardware configuration diagram of the unmanned aerial vehicle 100 and the external apparatus 121. It should be noted that, in a case in which the unmanned aerial vehicle 100 and the external apparatus 121 are explained without being particularly distinguished from each other, they may simply be referred to as a computer.

The computer includes a CPU 201, a ROM 202, a RAM 203, an HDD 204, an input device 205, an output device 206, and an I/F 207. The CPU 201, the ROM 202, the RAM 203, the HDD 204, the input device 205, the output device 206, and the I/F 207 are connected to one another via an internal bus.

The CPU 201 controls the entirety of the computer. The ROM 202 stores a BIOS. The RAM 203 is used as a work area of the CPU 201 and as temporary storage for loading software modules for realizing the present disclosure. The HDD 204 is an auxiliary storage device in which an OS, which is basic software, and software modules are stored. It should be noted that, instead of the HDD 204, a solid state drive (SSD) may be used. The input device 205 is a device used for inputting information, including a keyboard, a pointing device, and the like. The output device 206 is a device used for outputting information, including a display, a speaker, and the like. It should be noted that the input device 205 and the output device 206 may be integrally provided as a touch panel and the like. The I/F 207 is an interface for connecting to the network 120.

In the computer, after startup, the BIOS is executed by the CPU 201, and the OS is loaded from the HDD 204 into the RAM 203 in an executable manner. The CPU 201 loads, in accordance with the operation of the OS, various software modules described below from the HDD 204 into the RAM 203 in an executable manner, as needed. Additionally, various software modules of the computer are executed by the CPU 201, and operate accordingly.

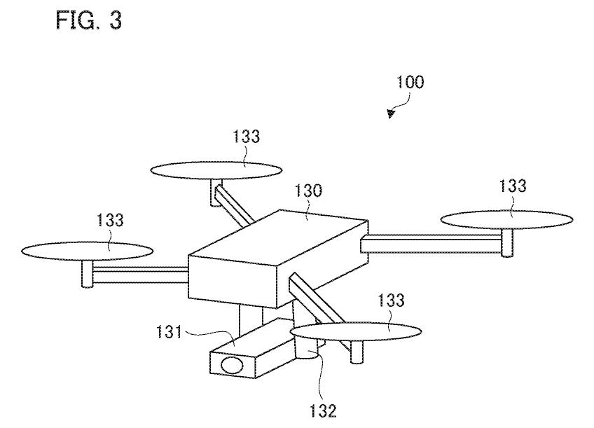

FIG. 3 is a diagram illustrating the external appearance of the unmanned aerial vehicle 100.

The unmanned aerial vehicle 100 includes a main body portion 130, a camera 131, a connection portion 132, and propellers 133.

The main body portion 130 is provided with various arithmetic units including the control unit 116, and is further provided with the storage unit 117, and the communication unit 118.

The camera 131, which is an example of an imaging unit, is provided with the imaging unit 110, and an imaging drive unit 115 for driving an imaging optical system of the imaging unit 110. The camera 131 is capable of capturing images while changing the zoom magnification, and the like.

The main body portion 130 and the camera 131 are connected to each other via the connection portion 132. The connection portion 132 is provided with a drive mechanism (not illustrated) that is rotatable about an attachment shaft relative to the main body portion 130, and about an attachment shaft relative to the camera 131. Driving the drive mechanism enables control of changing an orientation of the camera 131 relative to the main body portion 130 in a pan direction and a tilt direction. Additionally, the drive mechanism is rotatable within a predetermined range in response to a drive instruction from the imaging drive unit 115. Rotation of the drive mechanism to an arbitrary angle in this manner enables various types of imaging, including imaging in a state in which the camera 131 avoids an obstruction, and wide-angle imaging from above.

The propellers 133 are respectively connected to four sides of the main body portion 130. The propellers 133 are constituent elements of the flight drive unit 114, and rotation of the propellers 133 at arbitrary speeds enables desired flight of the unmanned aerial vehicle 100, such as ascent, descent, turning, forward movement, and the like. Although four propellers 133 are provided in the unmanned aerial vehicle 100 in the present embodiment, the number of propellers 133 that are provided in the unmanned aerial vehicle 100 is not limited thereto, and may be any number. Additionally, the unmanned aerial vehicle 100 may fly using a propulsion device that is different from the propellers 133.

It should be noted that the unmanned aerial vehicle 100 may be provided with a gimbal mechanism for removing vibration generated during flight. The gimbal mechanism enables imaging without image blur. Additionally, the unmanned aerial vehicle 100 may be provided, separately from the control unit 116, with a target detection unit that detects a search target, such as a heat source detection device including an infrared camera, a radio wave receiving device such as a radar, and the like.

Next, the details of a search performed by the unmanned aerial vehicle 100 will be explained.

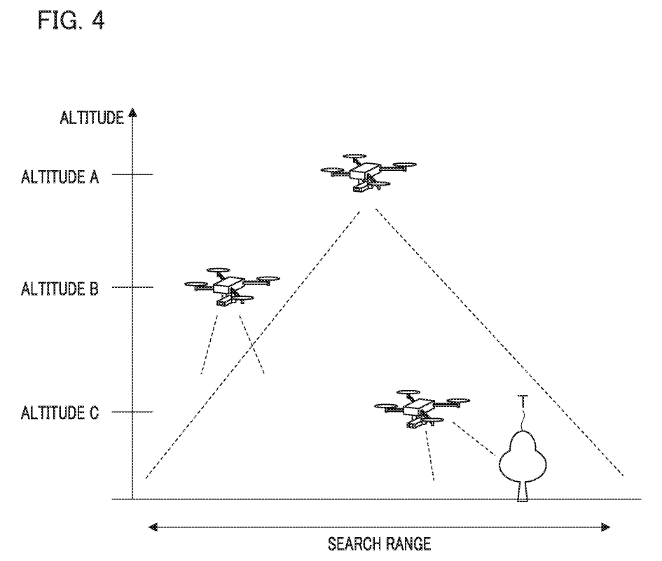

FIG. 4 is a diagram illustrating a relation between a search state of the unmanned aerial vehicle 100 and an altitude of the unmanned aerial vehicle 100.

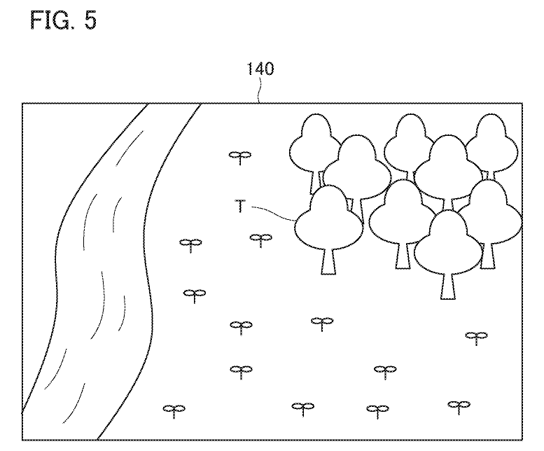

In a case in which the unmanned aerial vehicle 100 starts a search, the control unit 116 of the unmanned aerial vehicle 100 first causes the unmanned aerial vehicle 100 to fly at an altitude A via the imaging drive unit 115 and to image an entire area to be imaged, thereby generating an image 140 that is shown in FIG. 5. Here, the area to be imaged is a region that includes the entire search range. Additionally, in the present embodiment, both the area to be imaged and the search range are regions near the ground surface. Additionally, the altitude A corresponds to the altitude that is required for wide-angle imaging of the area to be imaged. Additionally, an image captured by the unmanned aerial vehicle 100 while the unmanned aerial vehicle 100 is flying at the altitude A is an image to be evaluated by the evaluation unit 112. An image to be evaluated by the evaluation unit 112, such as an image captured by the unmanned aerial vehicle 100 while the unmanned aerial vehicle 100 is flying at the altitude A, may hereinafter be referred to as an evaluation target image. The evaluation target image may also be regarded as a bird's-eye view image of the area to be imaged. In this example, the unmanned aerial vehicle 100 generates an evaluation target image 140, as shown in FIG. 5, by performing imaging in a state in which the unmanned aerial vehicle 100 is flying at altitude A.

Next, the evaluation unit 112 of the unmanned aerial vehicle 100 detects interfering objects such as obstructions in the evaluation target image 140.

In this example, a user operates the external apparatus 121 to designate trees as obstructions and to input an image of a tree into the external apparatus 121. In this case, the external apparatus 121 transmits, to the unmanned aerial vehicle 100, information indicating that the tree is an obstruction together with the image of the tree. The evaluation unit 112 of the unmanned aerial vehicle 100 then detects each of the trees T that are shown in the evaluation target image 140 as interfering objects. Additionally, in the illustrated example, the evaluation unit 112 does not detect any interfering objects in the regions of the evaluation target image 140 in which no trees T are shown.

Next, the evaluation unit 112 evaluates the ease of search in the area to be imaged that is shown in the evaluation target image 140 based on a detection result. The evaluation unit 112 evaluates ease of search to be low with respect to an area to be imaged corresponding to a region of the evaluation target image 140 in which a tree T is shown. Additionally, the evaluation unit 112 evaluates the ease of search to be high with respect to an area to be imaged corresponding to a region of the evaluation target image 140 in which no trees T are shown. The evaluation unit 112 generates an evaluation map that is a map of the area to be imaged that has been partitioned according to evaluation results.

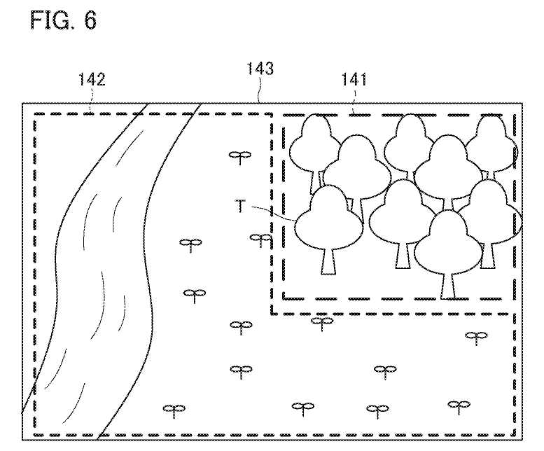

FIG. 6 is a diagram illustrating an evaluation map 143. The evaluation map 143 is a map in which sections corresponding to respective evaluations by the evaluation unit 112 are superimposed on the evaluation target image 140. A region 141 of the evaluation map 143 in which there are trees T shown corresponds to a region of the evaluation target image 140 that has been evaluated by the evaluation unit 112 as having low ease of search. Additionally, a region 142 of the evaluation map 143 in which there are no trees T shown corresponds to a region of the evaluation target image 140 that has been evaluated by the evaluation unit 112 as having a high ease of search. Note that the region 141 may hereinafter be referred to as a low-evaluation region 141. Additionally, the region 142 may hereinafter be referred to as a high-evaluation region 142.

Next, the search planning unit 113 of the unmanned aerial vehicle 100 determines the flight conditions and imaging conditions for a search plan based on the evaluation map 143.

In this example, when imaging an area to be imaged corresponding to the high-evaluation region 142, the search planning unit 113 determines the flight altitude of the unmanned aerial vehicle 100 as an altitude B (see FIG. 4). Additionally, when imaging an area to be imaged corresponding to the low-evaluation region 141 in which the tree T is shown, the search planning unit 113 determines the flight altitude of the unmanned aerial vehicle 100 to be an altitude C, which is lower than the altitude B. In this case, when imaging an area to be imaged corresponding to the high-evaluation region 142, the unmanned aerial vehicle 100 can perform image capturing over a wider range and increase hovering intervals, compared with when imaging an area to be imaged corresponding to the low-evaluation region 141. Additionally, during imaging of a target area corresponding to the low-evaluation region 141 by the unmanned aerial vehicle 100, occlusion of an object that is present near the ground surface by the tree T is suppressed.

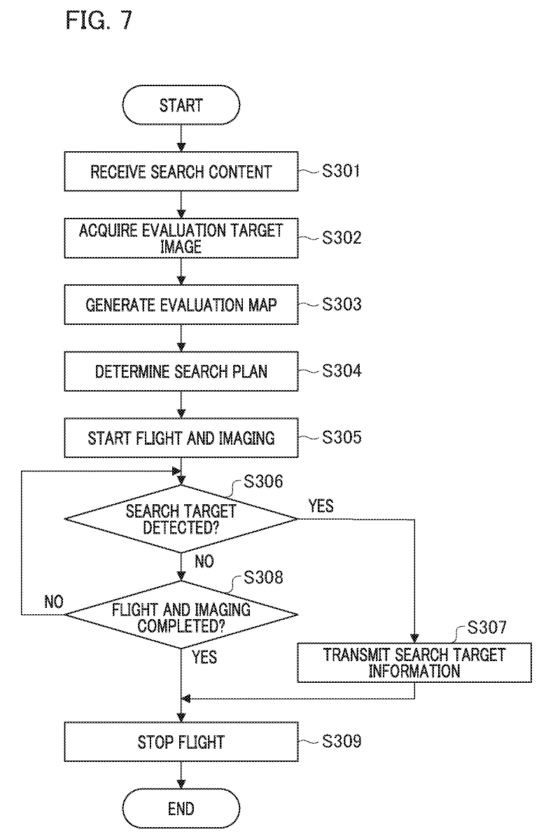

FIG. 7 is a flowchart illustrating the flow of search processing. The search processing is a process in which the unmanned aerial vehicle 100 performs a search.

The communication unit 118 of the unmanned aerial vehicle 100 receives, from the external apparatus 121, information indicating search details that have been specified by a user (step 301, hereinafter sometimes referred to as “S301”). Examples of the search details include information indicating a search target and information indicating a search range. Examples of the information indicating the search target include an image showing the search target. In the present embodiment, the control unit 116 of the unmanned aerial vehicle 100 searches for the search target, for example, by detecting a subject having a high degree of similarity to an image showing the search target. However, the information indicating the search target may be a generic term such as “person” or “dog.” In this case, the control unit 116 may detect the search target by image recognition. Additionally, examples of the information indicating the search range include information indicating coordinates such as latitude and longitude, and map information including the search range. Additionally, in the present embodiment, the user inputs the search details into the external apparatus 121 by operating the external apparatus 121.

The unmanned aerial vehicle 100 obtains an evaluation target image by imaging during flight (S302). In this example, the unmanned aerial vehicle 100 obtains the evaluation target image 140 that is shown in FIG. 5.

In a case in which not all of the search range is included in the angle of view of the camera 131 of the unmanned aerial vehicle 100, the unmanned aerial vehicle 100 may capture images of the search range in a plurality of operations. Additionally, an image that is different from an image that has been captured by the unmanned aerial vehicle 100, such as a satellite image, may be used as the evaluation target image. Furthermore, terrain information for a previously specified search range and the like may be used for evaluation by the evaluation unit 112.

The evaluation unit 112 of the unmanned aerial vehicle 100 detects interfering objects in the evaluation target image 140, evaluates the ease of search in the area to be imaged based on the detection result, and generates an evaluation map indicating the evaluation result (S303). In this example, the evaluation unit 112 generates the evaluation map 143 (see FIG. 6).

Note that the evaluation unit 112 may divide the area to be imaged shown in the evaluation target image into a plurality of regions, calculate a contrast ratio and/or image complexity for each divided region, and detect interfering objects based on calculation results.

Additionally, the evaluation unit 112 may determine interfering objects based on the relation of the interfering object to the search target.

For example, in a case in which the search target is a small object such as a small animal including a dog, and a person, trees may serve as obstructions to the search target. In contrast, in a case in which the search target is a large object such as a vehicle, and a large animal, the search target is less likely to be occluded by trees. Therefore, in a case in which the search target is a small animal such as a dog, and a person, it may be made such that trees are determined to be interfering objects, whereas in a case in which the search target is a vehicle or a large animal, it may be made such that trees are not determined to be interfering objects. Thus, the size of an object that has been determined as an interfering object may be determined in accordance with the search target.

Additionally, in a case in which the search target and an object that has the same color as the search target, and an object that has a similar color to the search target are displayed so as to overlap each other in the evaluation target image, it may be difficult to distinguish between the two. Additionally, in a case in which the search target and an object that has the same shape as the search target, and an object that has a similar shape to the search target are displayed so as to overlap with the search target in the evaluation target image, it may be difficult to distinguish between the object and the search target. Therefore, objects that have the same appearance (color, shape) as the search target, and objects that have a similar appearance (color, shape) to the search target may be determined as interfering objects. Thus, the type of appearance of an object to be determined as an interfering object may be selected according to the search target.

The search planning unit 113 of the unmanned aerial vehicle 100 determines a search plan based on the evaluation map 143 that has been generated by the evaluation unit 112 (S304). More specifically, the search planning unit 113 determines the flight conditions and imaging conditions as various control parameters for the flight drive unit 114 and the imaging drive unit 115.

The unmanned aerial vehicle 100 starts flight and imaging in accordance with the search plan that has been determined by the search planning unit 113 (S305). More specifically, the flight drive unit 114 of the unmanned aerial vehicle 100 starts flight in accordance with the search plan, and the camera 131 starts imaging in accordance with the search plan. Through the processing of step 305, flight by the unmanned aerial vehicle 100 and imaging of the area to be imaged are started.

The control unit 116 of the unmanned aerial vehicle 100 determines whether or not the search target has been detected in captured images generated by the imaging started in step 305 (S306).

It should be noted that the detection of the search target may be performed by a method that is different than the image recognition performed by the control unit 116 described above. For example, the unmanned aerial vehicle 100 may transmit captured images to the external apparatus 121. The user may detect the search target in the captured images displayed on the output device 206 of the external apparatus 121.

In a case in which the search target is detected (“YES” in step S306), the control unit 116 transmits information that represents the detected search target to the external apparatus 121 via the communication unit 118 (S307). Specifically, the control unit 116 transmits an image showing the search target and information indicating the coordinates of the detected search target to the external apparatus 121.

Additionally, in a case in which the search target is not detected (“NO” in step S306), the control unit 116 determines whether or not flight in accordance with the flight conditions and imaging in accordance with the imaging conditions have been completed (S308). The flight conditions and the imaging conditions are those that were determined by the search planning unit 113.

In a case in which flight in accordance with the flight conditions and imaging in accordance with the imaging conditions have not been completed (“NO” in step S308), the processing starting from step S306 is repeated. As a result, flights in accordance with the flight conditions and imaging of the area to be imaged in accordance with the imaging conditions continue until the search target is detected.

Additionally, after step S307, or in a case in which flight in accordance with the flight conditions and imaging in accordance with the imaging conditions have been completed (“YES” in step S308), the unmanned aerial vehicle 100 stops flight (S309), and the search processing ends.

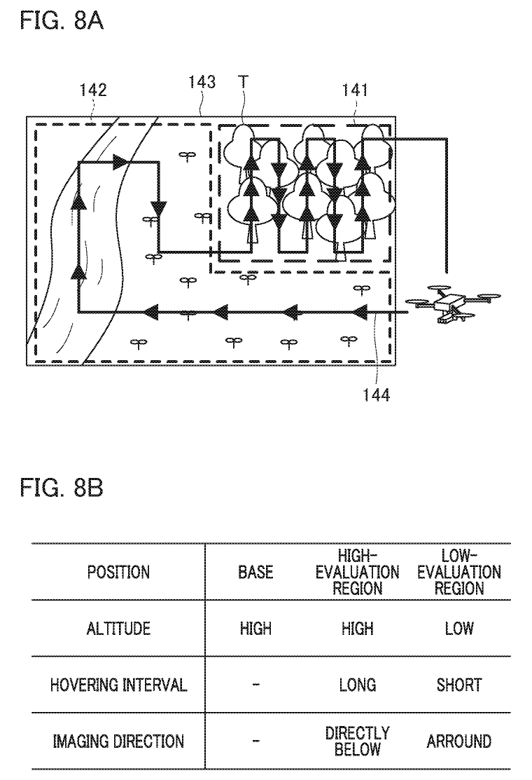

FIGS. 8A and 8B are diagrams illustrating flight conditions and imaging conditions, respectively, that constitute a search plan that has been determined by the search planning unit 113.

In FIG. 8A, the search plan that has been determined by the search planning unit 113 is superimposed on the evaluation map 143. The positions that are indicated by arrows in the evaluation map 143 indicate locations at which the unmanned aerial vehicle 100 is scheduled to hover over the area to be imaged. Note that a position over which the unmanned aerial vehicle 100 is scheduled to hover may also be regarded as an imaging position of the unmanned aerial vehicle 100. Additionally, the direction of each arrow shown in the evaluation map 143 indicates the orientation of the unmanned aerial vehicle 100 during flight. Additionally, a flight route is illustrated in the evaluation map 143. This flight route is one in which the unmanned aerial vehicle 100 first flies over the area to be imaged corresponding to the high-evaluation region 142, and thereafter flies over the area to be imaged corresponding to the low-evaluation region 141.

FIG. 8B illustrates flight conditions and imaging conditions corresponding to the position of the unmanned aerial vehicle 100.

In FIG. 8B, “base,” “high-evaluation region,” and “low-evaluation region” are illustrated as positions of the unmanned aerial vehicle 100. Here, “base” means a location at which the unmanned aerial vehicle 100 takes off and lands and corresponds to the position at which the unmanned aerial vehicle 100 is illustrated in FIG. 8A. “High-evaluation region” means over the area to be imaged corresponding to the high-evaluation region 142. “Low-evaluation region” means over the area to be imaged corresponding to the low-evaluation region 141.

Additionally, in FIG. 8B, either “high” or “low” is shown as the altitude of the unmanned aerial vehicle 100. Here, “high” means the altitude B (see FIG. 4), and “low” means the altitude C. In the present embodiment, when the unmanned aerial vehicle 100 is positioned over the base and over the area to be imaged corresponding to the high-evaluation region 142, the unmanned aerial vehicle 100 is set to fly at the altitude B. Additionally, when the unmanned aerial vehicle 100 is positioned over the area to be imaged corresponding to the low-evaluation region 141, the unmanned aerial vehicle 100 is set to fly at the altitude C.

Additionally, in FIG. 8B, either “long” or “short” is shown as the hovering interval of the unmanned aerial vehicle 100. Here, “long” means that, as compared with “short,” a time interval from when the unmanned aerial vehicle 100 performs hovering to when the unmanned aerial vehicle 100 next performs hovering is longer. In the present embodiment, when the unmanned aerial vehicle 100 is positioned over the area to be imaged that corresponds to the high-evaluation region 142, the hovering interval is set to “long.” Additionally, when the unmanned aerial vehicle 100 is positioned over the area to be imaged that corresponds to the low-evaluation region 141, the hovering interval is set to “short.” The hovering interval for each region to be imaged that has a different evaluation by the evaluation unit 112 is also illustrated in the evaluation map 143 of FIG. 8A, in which intervals between arrows shown in the high-evaluation region 142 are wider, whereas intervals between arrows shown in the low-evaluation region 141 are narrower.

Additionally, in FIG. 8B, either one of “directly below”, and “around” is shown as the orientation of the imaging unit 110 of the unmanned aerial vehicle 100. Here, “directly below” means a direction directly below relative to the orientation of the main body portion 130 (see FIG. 3) of the unmanned aerial vehicle 100. “Around” means peripheral directions around the main body portion 130. It should be noted that the orientation of the imaging unit 110 may also be regarded as the orientation of the camera 131.

Additionally, in the present embodiment, as described above, the flight route is set such that the unmanned aerial vehicle 100 first flies over the area to be imaged corresponding to the high-evaluation region 142, and thereafter flies over the area to be imaged corresponding to the low-evaluation region 141 (see FIG. 8A). According to this flight route, even if the unmanned aerial vehicle 100 moves from the base to over the area to be imaged that corresponds to the high-evaluation region 142, the altitude does not need to be changed. Additionally, when the unmanned aerial vehicle 100 returns to the base from over the area to be imaged that corresponds to the low-evaluation region 141, it lands without increasing the altitude. Therefore, compared with a case in which the unmanned aerial vehicle 100 flies over the area to be imaged corresponding to the low-evaluation region 141, and thereafter flies over the area to be imaged corresponding to the high-evaluation region 142, the number of altitude changes is reduced.

The unmanned aerial vehicle 100 performs the search in accordance with the plan shown in FIGS. 8A and 8B.

First, at the base, the unmanned aerial vehicle 100 ascends to the altitude B (see FIG. 4), and then moves to over the area to be imaged that corresponds to the high-evaluation region 142. When the unmanned aerial vehicle 100 flies over the area to be imaged that corresponds to the high-evaluation region 142, there are no interfering objects such as obstructions, and the presence or absence of the search target can be relatively easily detected by the control unit 116. Therefore, in order to perform image capturing over a wider range, the unmanned aerial vehicle 100 performs image capturing while flying at the altitude B. Additionally, in order to suppress blur in captured images, the unmanned aerial vehicle 100 needs to hover during imaging, and since a wide range is covered, the hovering interval can be lengthened. Additionally, after capturing an image while hovering in a downward direction relative to the orientation of the main body portion 130, the unmanned aerial vehicle 100 moves to the next scheduled hovering position. In other words, when the unmanned aerial vehicle 100 is flying over the area to be imaged that corresponds to the high-evaluation region 142, the number of times that imaging is performed at each hovering position is one time per hovering position. In this case, compared with a case in which multiple images are captured at each hovering position, the search time of the unmanned aerial vehicle 100 is reduced, the data size of images that are obtained by the unmanned aerial vehicle 100 is suppressed, and the processing load for imaging by the unmanned aerial vehicle 100 is reduced.

After completing imaging of the area to be imaged that corresponds to the high-evaluation region 142, the unmanned aerial vehicle 100 moves to over the area to be imaged that corresponds to the low-evaluation region 141. When the unmanned aerial vehicle 100 flies over the area to be imaged that corresponds to the low-evaluation region 141, due to the presence of a tree T, imaging from various angles while flying at a low altitude is required so as to avoid the tree T. Therefore, the unmanned aerial vehicle 100 performs imaging while flying at the altitude C (see FIG. 4), which is a low altitude that does not result in contact with the tree T. Note that the search planning unit 113 detects the height of interfering objects such as obstructions from the evaluation target image 140 and determines the altitude based on the detected height. However, in a case in which the height of an interfering object is not detected from the evaluation target image 140, when the unmanned aerial vehicle 100 flies near the interfering object during the search, the unmanned aerial vehicle 100 may detect the interfering object from a captured image showing the interfering object, and adjust the altitude based on the detection result. Additionally, in a case in which the unmanned aerial vehicle 100 flies at the altitude C, the angle of view becomes narrower than in a case in which the unmanned aerial vehicle 100 flies at the altitude B, and therefore the unmanned aerial vehicle 100 needs to shorten the hovering interval. Additionally, in order to avoid occlusion of an area near the ground surface by the tree T, the unmanned aerial vehicle 100 captures images a plurality of times while hovering and rotating the imaging unit 110 in directions around the main body portion 130. When the unmanned aerial vehicle 100 is flying over the area to be imaged that corresponds to the low-evaluation region 141, the number of images captured at each hovering position is, for example, four images per hovering position, taken in the front, rear, left, and right directions of the main body portion 130. However, the unmanned aerial vehicle 100 may change the hovering positions and the number of images captured at each hovering position in accordance with the actual conditions of interfering objects.

After completing imaging of the area to be imaged that corresponds to the low-evaluation region 141, the unmanned aerial vehicle 100 returns to the base. As a result, flight in accordance with the flight conditions and imaging in accordance with the imaging conditions that have been determined by the search planning unit 113 are completed (“YES” in step S308 of FIG. 7), and the search performed by the unmanned aerial vehicle 100 is completed.

As described above, the unmanned aerial vehicle 100 of the present embodiment evaluates the ease of search from an image showing the area to be imaged and performs the search in accordance with flight conditions and imaging conditions that have been determined based on the evaluation result, thereby achieving an efficient search.

In the present embodiment, when a region for which the evaluation from the evaluation unit 112 is low and a region for which the evaluation from the evaluation unit 112 is high are both included in the area to be imaged, the search planning unit 113 determines the flight route such that the search is performed starting from the region for which the evaluation is high. However, the present disclosure is not limited thereto.

In a case in which both a low-evaluation region and a high-evaluation region as evaluated by the evaluation unit 112 are included in the area to be imaged, the flight route may also be determined by the search planning unit 113 such that the search is performed starting from the low-evaluation region, and the search order may also be arbitrary. However, in a configuration in which the flight route is determined such that the search is performed starting from the high-evaluation region, in a case in which the search target is detected in the high-evaluation region (“YES” in step S306 of FIG. 7), the search processing is completed, and the low-evaluation region does not need to be searched. Even in this case, in a case in which the search target is not detected in the high-evaluation region (“NO” in step S306 of FIG. 7), the low-evaluation region evaluated is also searched.

Additionally, in the present embodiment, it is explained that the unmanned aerial vehicle 100 may be provided, separately from the control unit 116, with a target detection unit for detecting the search target. Here, the search planning unit 113 may determine that the target detection unit will not be used in a case in which the area to be imaged that corresponds to the high-evaluation region 142 will be searched, and that the target detection unit will be used to detect the search target in a case in which the area to be imaged that corresponds to the low-evaluation region 141 will be searched.

Additionally, in a case in which the unmanned aerial vehicle 100 searches the area to be imaged that corresponds to the high-evaluation region 142, the search planning unit 113 may determine that the shutter speed of the imaging unit 110 will be increased and that image capturing will be performed while the unmanned aerial vehicle 100 is moving without hovering. Additionally, the search planning unit 113 may increase the flight speed of the unmanned aerial vehicle 100 in the area to be imaged that corresponds to the high-evaluation region 142 in comparison with the flight speed in the area to be imaged that corresponds to the low-evaluation region 141.

Additionally, the external apparatus 121 may evaluate the ease of search, and determine a search plan. In other words, the CPU 201 of the external apparatus 121 may have the functions of the image evaluation unit 112, and the search planning unit 113. The external apparatus 121 may obtain an evaluation target image from the unmanned aerial vehicle 100, and another apparatus, evaluate the ease of search, and determine flight conditions and imaging conditions for a search plan.

Additionally, the evaluation target image may be an image that has been captured from directly above the area to be imaged, or may be an image that has been captured from a position above the area to be imaged at an angle that is relative to a direction directly above the area to be imaged. That is, as long as the evaluation target image is captured from above the area to be imaged, it may be captured from any position. The height of an interfering object can be more easily detected based on the evaluation target image in a case in which the evaluation target image is an image that has been captured from a position above the area to be imaged at an angle relative to the direction directly above the area to be imaged.

As described above, in the present disclosure, the evaluation unit 112 of the unmanned aerial vehicle 100 detects an obstruction in the area to be imaged from an evaluation target image in which the area to be imaged is captured from above the area to be imaged by the camera 131 of the unmanned aerial vehicle 100. Then, the search planning unit 113 determines the altitude of the unmanned aerial vehicle 100 when the area to be imaged is captured by the camera 131, based on the detection result of the evaluation unit 112.

In this case, imaging conditions suitable for the area to be imaged are set.

Additionally, in the present disclosure, it has been explained that, in accordance with the search target, the size of an object that has been determined as an interfering object may be determined, and the appearance of an object that has been determined as an interfering object may be determined. That is, an obstruction is an object that is determined based on the relation with the search target.

In this case, a search for an object is realized using an image that has been captured by the unmanned aerial vehicle 100 under imaging conditions that take into consideration whether or not an object that is present in the area to be imaged has been determined based on the relation with the search target.

Additionally, the evaluation unit 112 evaluates the ease of search as being high for an area to be imaged in which no interfering object has been detected. In this case, the search planning unit 113 determines the altitude of the unmanned aerial vehicle 100 in the area to be imaged as the altitude B (see FIG. 4). On the other hand, the evaluation unit 112 evaluates the ease of search as being lower than the ease of search for an area to be imaged in which no interfering object has been detected for an area to be imaged in which an interfering object has been detected. Then, in this case, the search planning unit 113 may determine the altitude of the unmanned aerial vehicle 100 in an area to be imaged in which an interfering object has been detected as the altitude C. That is, when an area to be imaged in which an obstruction has been detected is captured by the camera 131, the search planning unit 113 determines the flight altitude of the unmanned aerial vehicle 100 to be lower than the flight altitude of the unmanned aerial vehicle 100 in an area to be imaged in which no obstruction has been detected by the evaluation unit 112.

In this case, as compared with a case in which the altitude of the unmanned aerial vehicle 100 in an area to be imaged in which an obstruction has been detected is the same as the altitude of the unmanned aerial vehicle 100 in an area to be imaged in which no obstruction has been detected, the hindering of the imaging of the search target that is caused by the obstruction is suppressed.

Additionally, the search planning unit 113 restricts the detection of a search target by the target detection unit in an area to be imaged in which no obstruction has been detected by the evaluation unit 112. Then, the search planning unit 113 causes the target detection unit to detect a search target in an area to be imaged in which an obstruction has been detected by the evaluation unit 112.

In this case, the power consumption of the unmanned aerial vehicle 100 is reduced in comparison with a configuration in which the target detection unit detects a search target in an area to be imaged regardless of whether or not an obstruction has been detected.

Additionally, the evaluation target image that is used for detection by the evaluation unit 112 is an image that has been captured by the camera 131.

In this case, it is not necessary to obtain an image for use in detecting an obstruction from a device that is different from the unmanned aerial vehicle 100.

Additionally, in a case in which an area to be imaged includes a plurality of regions in which the detection results differ, the search planning unit 113 determines, for each of the plurality of regions, an altitude of the unmanned aerial vehicle 100 for when each region is imaged by the camera 131.

In this case, a search for an object is realized that uses an image that has been captured by the unmanned aerial vehicle 100 under imaging conditions that have been determined in consideration of the objects present in each region in which detection results differ.

Additionally, in a case in which a plurality of regions having different detection results are regions for which the altitudes of the unmanned aerial vehicle 100 that were determined when captured by the camera 131 are different from each other, the search planning unit 113 determines, based on a predetermined rule, an order in which the regions are to be captured by the camera 131. Examples of the predetermined rule include a rule for performing the search in order from an area to be imaged that has a lower evaluation and a rule for performing the search in order from an area to be imaged that has a higher evaluation.

In this case, in a case in which regions exist for which different flight altitudes of the unmanned aerial vehicle 100 are determined when captured by the camera 131, image capturing without determining an order is prevented.

Additionally, the plurality of regions that have different detection results includes a first region in which a flight altitude of the unmanned aerial vehicle 100 when captured by the camera 131 is determined as a first altitude, and a second region in which a flight altitude of the unmanned aerial vehicle 100 when captured by the camera 131 is determined as a second altitude, which is higher than the first altitude. Examples of the first altitude include the altitude C. Examples of the first region include an area to be imaged that corresponds to the low-evaluation region 141. Examples of the second altitude include the altitude B. Examples of the second region include an area to be imaged that corresponds to the high-evaluation region 142. Then, the search planning unit 113 determines that the camera 131 captures the second region before the first region.

In this case, the search is performed starting from an area to be imaged in which wide-angle imaging can be performed.

Additionally, in the present disclosure, it has been explained that either the unmanned aerial vehicle 100 or the external apparatus 121 may determine the search plan. That is, an acquisition unit of the information processing apparatus acquires a detection result for a predetermined object in an area to be imaged, the detection being performed on an evaluation target image that has been obtained by capturing the area to be imaged from above the area to be imaged is captured by the camera 131 of the unmanned aerial vehicle 100. Examples of the acquisition unit include the evaluation unit 112 of the unmanned aerial vehicle 100, and the CPU 201 of the external apparatus 121. In this case, the CPU 201 of the external apparatus 121 may obtain a detection result by detecting a predetermined object in an area to be imaged based on the evaluation target image, and may obtain the detection result from the unmanned aerial vehicle 100. Examples of the predetermined object include an interfering object. Then, a determination unit of the information processing apparatus determines imaging conditions for capturing an area to be imaged by the camera 131 in accordance with a result acquired by the acquisition unit. Examples of the determination unit include the search planning unit 113 of the unmanned aerial vehicle 100, and the CPU 201 of the external apparatus 121.

Even in this case, a search for an object is achieved that uses an image that was captured by the unmanned aerial vehicle 100 under imaging conditions that take into consideration objects present in the area to be imaged.

### Other Embodiments

Additionally, the present disclosure also includes supplying a software program for realizing the functions of the above-described embodiment to a system or an apparatus having a computer capable of executing the program, either directly from a recording medium or via wired or wireless communication, and executing the program.

Accordingly, program code itself that is supplied to and installed in a computer in order to realize the above-described functional processing of the present disclosure by the computer also realizes the present disclosure. That is, a computer program itself for realizing the functional processing of the present disclosure is also included in the present disclosure. In that case, as long as the functions of the program are had, the form of the program is not limited, and may be an object code, a program executed by an interpreter, script data that is supplied to an operating system, and the like. Examples of the recording medium for supplying the program include a magnetic recording medium such as a hard disk or a magnetic tape, an optical/magneto-optical storage medium, and a non-volatile semiconductor memory. Additionally, as a method of supplying the program, a method is also conceivable in which a computer program that forms the present disclosure is stored in a server on a computer network, and a client computer that has established a connection downloads and executes the computer program.

Additionally, based on an instruction of the program code, an OS and the like operating on the computer may perform a part or all of actual processing, and each function of the above-explained embodiment may be realized by the processing. Furthermore, the program code that has been read out from a recording medium may be written into a memory that is provided in a function expansion board and inserted into the computer, and in a function expansion unit that is connected to the computer. Then, based on the instructions of the program code, a CPU and the like that is provided in the function expansion board, and the function expansion unit may perform part or all of the actual processing. Even in this case, each function of the above-described embodiment is realized.

According to the present disclosure, imaging conditions suitable for the area to be imaged can be set.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074946, filed Apr. 28, 2025, which is hereby incorporated by reference herein in its entirety.

What is claimed is:

1. An unmanned aerial vehicle comprising:
a flight unit configured to cause the unmanned aerial vehicle to fly at a predetermined altitude;
an imaging unit configured to obtain images by performing imaging in a state in which the unmanned aerial vehicle is flying;
at least one memory storing instructions; and
at least one processor executing the stored instructions causing the unmanned aerial vehicle to:
detect an obstruction in a target area to be imaged by the imaging unit from an image in which the target area is captured from above the target area; and
determine, according to a result of the detection, an altitude of the unmanned aerial vehicle during capturing the target area by the imaging unit.

2. The unmanned aerial vehicle according to claim 1, wherein the obstruction is an object determined based on a relation with a search target.

3. The unmanned aerial vehicle according to claim 1, wherein executing the stored instructions by the processor further causes the unmanned aerial vehicle to determine the altitude of the unmanned aerial vehicle during capturing the target area in which the obstruction is detected by the imaging unit to be lower than the altitude of the unmanned aerial vehicle during capturing the target area in which the obstruction has not been detected by the imaging unit.

4. The unmanned aerial vehicle according to claim 1,
wherein executing the stored instructions by the processor further causes the unmanned aerial vehicle to:
detect a search target; and
restrict detection of the search target in the target area in which the obstruction has not been detected, and cause detection of the search target in the target area in which the obstruction is detected.

5. The unmanned aerial vehicle according to claim 1, wherein the image used for the detection is an image that has been captured by the imaging unit.

6. The unmanned aerial vehicle according to claim 1, wherein executing the stored instructions by the processor further causes the unmanned aerial vehicle to, in a case in which the target area includes a plurality of regions having different results of the detection, determine, for each of the plurality of regions, the altitude of the unmanned aerial vehicle during capturing each of the plurality of regions by the imaging unit.

7. The unmanned aerial vehicle according to claim 6, wherein executing the stored instructions by the processor further causes the unmanned aerial vehicle to, in a case in which the determined altitudes of the unmanned aerial vehicle during capturing the plurality of regions by the imaging unit are different from each other, determine, based on a predetermined rule, an order of the regions to be captured by the imaging unit.

8. The unmanned aerial vehicle according to claim 6,
wherein the plurality of regions include: a first region in which the altitude of the unmanned aerial vehicle during capturing by the imaging unit is determined to be a first altitude; and a second region in which the altitude of the unmanned aerial vehicle during capturing by the imaging unit is determined to be a second altitude that is higher than the first altitude, and
wherein executing the stored instructions by the processor further causes the unmanned aerial vehicle to determine to capture the second region by the imaging unit prior to the first region.

9. An information processing apparatus comprising:
at least one memory storing instructions; and
at least one processor executing the stored instructions causing the information processing apparatus to:
acquire a detection result of a predetermined object in a target area to be imaged by an imaging unit of an unmanned aerial vehicle from an image in which the target area is captured from above the target area; and
determine, according to the acquired result, imaging conditions for capturing the target area by the imaging unit.

10. A control method of an unmanned aerial vehicle including a flight unit configured to cause the unmanned aerial vehicle to fly at a predetermined altitude, and an imaging unit configured to obtain images by performing imaging in a state in which the unmanned aerial vehicle is flying, the control method comprising:
detecting an obstruction in a target area to be imaged by an imaging unit from an image in which the target area is captured from above the target area; and
determining, according to a result of the detection, an altitude of the unmanned aerial vehicle during capturing the target area by the imaging unit.

11. A non-transitory storage medium storing a program for an unmanned aerial vehicle, the unmanned arial vehicle including a flight unit configured to cause the unmanned aerial vehicle to fly at a predetermined altitude, and an imaging unit configured to obtain images by performing imaging in a state in which the unmanned aerial vehicle is flying, the program causing a computer to perform each step of the control method according to claim 10.
